(19) United States
(12) Patent Application Publication
(10) Pub. No.: US 2023/0095342 A1
(43) Pub. Date: Mar. 30, 2023

(54) A METHOD OF OPERATING A TIME OF FLIGHT CAMERA

(71) Applicant: Waikatolink Limited, Hamilton (NZ)

(72) Inventors: Carl Alexander LICKFOLD, Hamilton (NZ); Lee Vincent STREETER, Hamilton (NZ)

(73) Assignee: Waikatolink Limited, Hamilton (NZ)

(21) Appl. No.: 17/909,158

(22) PCT Filed: Mar. 5, 2021
(86) PCT No.: PCT/NZ2021/050035

§ 371 Date: Sep. 2, 2022

(30) Foreign Application Priority Data
Mar. 5, 2020 (NZ) 762332

(51) Int. Cl. G01S 17/894; G01S 7/4915; H04N 5/225; H04N 17/00; G06T 5/00; G06T 5/50

(52) U.S. Cl. CPC G01S 17/894; G01S 7/4915; G06T 5/006; G06T 5/50; H04N 5/2256; H04N 17/002; G06T 2207/10028; G06T 2207/20224

(57) ABSTRACT

In one aspect the invention provides a method of operating a time of flight camera which includes the steps of capturing a sequence of time of flight camera data frames using a set of step frequency modulation signals to provide a time of flight camera data set, then completing a spectral analysis of the dataset which identifies frequency and phase value pairs indicative of the range of the camera to an object represented in the data frames. Next an estimated camera range value to an object represented in the data frames is determined using the frequency value, then a corrected camera range value is determined using the estimated camera range value and the phase value. A camera output is then provided which identifies the corrected range values of at least one object represented in the data frames of the dataset.

### FIELD OF THE INVENTION

This invention relates to a time of flight camera and methods of operating this time of flight camera. In preferred embodiments the invention may be used to provide and operate a stepped frequency continuous wave time of flight camera which can provide accurate range measurements without requiring the use of a computationally intensive data processing algorithm.

### BACKGROUND OF THE INVENTION

Time of flight camera systems are able to resolve distance or depth information from light which has been modulated and reflected from an object in a scene. These camera systems calculate a distance measurement for objects in a scene based on information extracted from received reflected light.

One form of time of flight camera implementation employs amplitude modulated continuous wave light transmissions — AMCW. With these systems data for a single image is captured by taking measurements of received reflected light which has been modulated with a number of different phase offsets. These different phase offset values provide data which can be processed to resolve the distance between a particular target object and a receiving camera. These systems are relatively easy to implement with the signals used being computationally straightforward to process. An example of this type of AMCW time of flight range imaging technology is disclosed in the patent specification published as PCT Publication No. W02004/090568.

An alternative form of time of flight camera employs stepped frequency continuous wave light transmissions — SFCW. With this implementation data for a single image is captured by taking measurements of received reflected light which has been modulated with a number of different frequencies. Again the use of a periodic modulation signal which changes in frequency by a regular amount provides data which can be processed to resolve the distance between a particular target object to a receiving camera sensor. Spectral analysis of this sensor data provides frequency information which indicates the range from the sensor to reflecting objects in the scene under investigation.

SFCW techniques can be utilised as an alternative to AMCW systems, and in particular applications may mitigate problems experienced in AMCW systems by phase wrapping at or past an ‘ambiguity distance’. This problem is caused by AMCW techniques using phase information to determine range information, and the inability to distinguish the range of objects separated by a multiple of the wavelength of the modulation frequency used.

Conversely the resolvable range of SFCW systems is dictated by the number and size of the frequency steps applied to the modulation signal used, which ultimately is determined by the bandwidth of the sensor used in the camera. These camera systems therefore do not confuse the range of objects in the field of view of the camera and can provide accurate range information over a specific distance.

However there are limitations to the accuracy of range information which can be derived from the frequency based results utilised by SFCW camera systems. Due to the high frequency signals used and the short acquisition time involved with the capture of measurements these SFCW cameras commonly need to employ additional data processing techniques. For example it is common for zero padding spectral interpolation techniques to be implemented in combination with these types of cameras to add additional zero signal results to the measurement data to extend the effective time period spanned by the data when subject to later spectral analysis. This interpolation process results in a larger number of resolvable frequencies during spectral analysis at the expense of significantly increasing the size of the data set which needs to be processed. The accuracy of the results obtained is therefore increased, but at the cost of processing a much larger data set to identify object range information.

It would be of advantage to have improvements in the field of stepped frequency continuous wave time of flight camera systems which improved on the prior art or provided an alternative choice to the prior art. In particular it would be of advantage to have a stepped frequency continuous wave time of flight camera which could provide accurate range information without using a computationally intensive data processing algorithm such as a zero padding spectral interpolation technique.

### DISCLOSURE OF THE INVENTION

According to one aspect of the invention there is provided a time-of-flight camera which includes
a signal generator configured to generate a source modulation signal and to modify the frequency of the source modulation signal by at least one multiple of an offset frequency,
a camera light source configured to transmit light modulated by a modulation signal generated by the signal generator
a camera sensor configured to capture time of flight camera data frames from received reflected light,
a processor configured to compile a data set from captured time of flight data frames and to
   complete a spectral analysis of the received dataset which identifies frequency and phase value pairs indicative of the range of the camera to an object represented in the data frames, and
   determine an estimated camera range value to an object represented in the data frames using the frequency value, and
   determine a corrected camera range value using the estimated camera range value and the phase value, and
   providing a camera output which identifies the corrected range values of objects represented in the data frames of the dataset.

According to a further aspect of the invention there is provided a time of flight camera substantially as described above wherein the processor includes instructions to execute the additional preliminary step of applying a calibration to the frames of the captured data set or during the capture of the data set so that the results of the spectral analysis yields a zero phase value when interpolated to a zero frequency value.

According to another aspect of the invention there is provided a time of flight camera substantially as described above wherein the calibration applied specifies a rotation to be applied to a phase value associated with each modulation frequency used to capture a data frame.

According to a further aspect of the invention there is provided a time of flight camera substantially as described above wherein the processor includes instructions to execute the additional preliminary step of ordering the data frames of the camera data set to present the camera data frame captured using light modulated with the highest frequency modulation signal as the first data frame of the captured data set.

According to another aspect of the invention there is provided a time of flight camera substantially as described above wherein the signal generator modifies the frequency of the source modulation signal by the subtraction of at least one multiple of an offset frequency to provide an updated stepped modulation signal.

A set of computer executable instructions for a processor of a time of flight camera, said instructions executing the steps of:
capturing a sequence of time of flight camera data frames using a set of step frequency modulation signals to provide a time of flight camera data set,
completing a spectral analysis of the dataset which identifies frequency and phase value pairs indicative of the range of the camera to an object represented in the data frames, and
determining an estimated camera range value to an object represented in the data frames using the frequency value, and
determining a corrected camera range value using the estimated camera range value and the phase value, and
providing a camera output which identifies the corrected range values of at least one object represented in the data frames of the dataset.

A method of operating a time of flight camera which includes the steps of:
capturing a sequence of time of flight camera data frames using a set of step frequency modulation signals to provide a time of flight camera data set,
completing a spectral analysis of the dataset which identifies frequency and phase value pairs indicative of the range of the camera to an object represented in the data frames, and
determining an estimated camera range value to an object represented in the data frames using the frequency value, and
determining a corrected camera range value using the estimated camera range value and the phase value, and
providing a camera output which identifies the corrected range values of at least one object represented in the data frames of the dataset.

According to one aspect of the present invention there is provided a method of operating a time of flight camera characterised by the steps of:
i. capturing a sequence of time of flight camera data frames using a set of step frequency modulation signals to provide a time of flight camera data set, said captured data frames being ordered in the camera data set to present the camera data frame captured using light modulated with the highest frequency modulation signal as the first data frame of the camera data set, and
ii. processing the data set to determine range information for objects reflecting light to the camera sensor.

According to a further aspect of the present invention there is provided a method of operating a time of flight camera characterised by the steps of:
1. generating a source modulation signal,
2. transmitting light modulated by the source modulation signal from a camera light source and capturing a time of flight camera data frame from a camera sensor illuminated with reflected light modulated by the source modulation signal,
3. modifying the frequency of the source modulation signal by an offset frequency value,
4. transmitting light modulated by the stepped modulation signal from the camera light source and capturing a time of flight camera data frame from the camera sensor illuminated with reflected light modulated by the stepped modulation signal,
5. modifying the frequency of the stepped modulation signal by the offset frequency value to generate an updated stepped modulation signal,
6. transmitting light modulated by the updated stepped modulation signal from the camera light source and capturing a time of flight camera data frame from the camera sensor illuminated with reflected light modulated by the updated stepped modulation signal,
7. repeating steps e and f to generate further updated stepped modulation signals and capturing time of flight camera data frames using said updated modulation signals to provide a time of flight camera data set,
8. ordering the camera data frames of the camera data set to present the camera data frame captured using light modulated with the highest frequency modulation signal as the first data frame of the camera data set, and
9. processing the data set to determine range information for objects reflecting light to the camera sensor.

According to another aspect of the present invention there is provided a method of operating a time of flight camera characterised by the steps of:
a) generating a source modulation signal,
b) transmitting light modulated by the source modulation signal from a camera light source and capturing a time of flight camera data frame from a camera sensor illuminated with reflected light modulated by the source modulation signal,
c) reducing the frequency of the source modulation signal by an offset frequency value to provide a stepped modulation signal
d) transmitting light modulated by the stepped modulation signal from the camera light source and capturing a time of flight camera data frame from the camera sensor illuminated with reflected light modulated by the stepped modulation signal,
e) reducing the frequency of the stepped modulation signal by the offset frequency value to generate an updated stepped modulation signal,
f) transmitting light modulated by the updated stepped modulation signal from the camera light source and capturing a time of flight camera data frame from the camera sensor illuminated with reflected light modulated by the updated stepped modulation signal,
g) repeating steps e and f to generate further lower frequency stepped modulation signals and capturing time of flight camera data frames using said updated modulation signals to provide a time of flight camera data set,
h) Processing the data set to determine range in to use information for objects reflecting light to the camera sensor.

According to a further aspect of the present invention there is provided a method of operating a time of flight camera substantially as described above wherein the phase of the modulation signal is modified by an offset phase value when the frequency of the modulation signal is modified by the offset frequency value, and the data set is processed by performing a spectral analysis to identify frequency values indicative of range information for objects reflecting light to the camera sensor and frequency values falling within a noise shift frequency band are ignored.

According to another aspect of the present invention there is provided a time of flight camera which includes
a signal generator configured to generate a source modulation signal and to modify the frequency of the source modulation signal by at least one multiple of an offset frequency,
a camera light source configured to transmit light modulated by a modulation signal generated by the signal generator a camera sensor configured to capture time of flight camera data from received reflected light,
a processor configured to compile a data set from captured time of flight data frames and to process said data set to determine range information for objects reflecting light to the camera sensor, wherein the data set compiled is ordered to present the camera data frame captured using light modulated with the highest frequency modulation signal as the first data frame of the camera data set.

According to yet another aspect of the invention there is provided a computer readable medium embodying a program of computer executable instructions arranged to operate a time of flight camera, the program of instructions including:
at least one instruction to generate a source modulation signal,
at least one instruction to transmit light modulated by the source modulation signal from a camera light source and to capture a time of flight camera data frame from a camera sensor Illuminated with reflected light modulated by the source modulation signal,
at least one instruction to modify the frequency of the source modulation signal by an offset frequency value to generate a stepped modulation signal at least one instruction to transmit light modulated by the stepped modulation signal from the camera light source and to capture a time of flight camera data frame from the camera sensor illuminated with reflected light modulated by the stepped modulation signal,
at least one instruction to modify the frequency of the stepped modulation signal by the offset frequency value to generate an updated stepped modulation signal
at least one instruction to transmit light modulated by the updated stepped modulation signal from the camera light source and capture a time of flight camera data frame from the camera sensor illuminated with reflected light modulated by the updated stepped modulation signal,
at least one instruction to generate one or more further updated stepped modulation signals and to capture one or more further time of flight camera data frames using said updated modulation signals to compile a time of flight camera data set ordered to present the camera data frame captured using light modulated with the highest frequency modulation signal as the first data frame of the camera data set, and
at least one instruction to process the data set to determine range information for objects reflecting light to the camera sensor.

Various aspects of the present invention can provide a time of flight camera, a method of operating such a camera, and/or a program of computer executable instructions configured to operate a time of flight camera. Reference throughout this specification in general is predominantly made to the invention providing a method of operating a time of flight camera, while those skilled in the art should appreciate that this should in no way be seen as limiting. In various aspects the invention may be embodied by a time of flight camera incorporating a signal generator, camera light source, camera sensor and processor — this processor preferably programmed with executable instructions which implement the method of operation discussed below.

Those skilled in the art should also appreciate that the components or hardware employed to form this time of flight camera may be drawn from or provided by existing prior art time-of-flight cameras. Such existing cameras may be readily modified or configured to generate and modify modulation signals, to transmit modulated light and also to capture and process camera data frames using forms of existing camera signal generators, light sources, sensors and processors.

Furthermore any reference made to the invention including a single processor should be read as encompassing the use of distributed networks of processors, or alternatively edge devices configured to provide a camera output which identifies corrected range values.

The present invention is arranged to provide a camera output which identifies the corrected range values of at least one object represented in the data frames of the dataset. Those skilled in the art will appreciate that this camera output may be formatted in many different ways depending on the application in which the camera is used. In some embodiments an image may be presented as a camera output, where the colour of individual pixels of this image indicate both position and corrected range values for an object in the field of view of the camera. In other embodiments camera output may take the form of a Boolean variable which can indicate the presence or absence of an object at one or more range values from the camera. In yet other embodiments camera output may be provided to a machine vision system, where the format and content delivered will be determined by the requirements of the receiving system.

The present invention provides for the capture and processing of a plurality of time of flight camera data frames which are compiled together to define a time of flight camera data set.

Each camera data frame is captured with the use of a modulation signal employed by a camera light source. This modulation signal is used by the light source to modulate light transmitted towards objects which are to have their range to the camera measured. The modulated light is then reflected from these objects towards and onto the time-of-flight camera sensor.

The present invention utilises a different modulation signal in respect of each captured data frame compiled into an entire camera data set. These modulation signals provide a set of step frequency modulation signals which all differ from each other by the addition or subtraction of a multiple of an offset frequency value. This offset frequency value therefore defines a step change in frequency between the members of the set of modulation signals used.

For example, one data frame may be captured using a source modulation signal which can set a baseline or initial signal. For each subsequently captured data frame the modulation signal used may be formed by a modified version of the source modulation signal and/or the modulation signal used to generate the previously captured data frame. In some embodiments the first data frame may be captured using light modulated by the source modulation signal. A second data frame may then be captured using a stepped modulation signal, being a modified version of the source modulation signal. A third data frame may then be captured using yet another modulation signal, preferably being an updated form of the stepped modulation signal, which itself is a modified version of the original source modulation signal. Those skilled in the art appreciate that updated stepped modulation signals may be generated for the required number of frames used to form a data set processed by the time of flight camera.

As indicated above, a previously used modulation signal may be modified to capture a new data frame by modifying the frequency of the signal using an offset frequency value. In a number of embodiments the offset frequency value may remain constant each time a modulation signal is to be modified, therefore linearly increasing or decreasing modulation signal frequency as camera data frames are captured for a single camera data set.

In some embodiments, and as discussed further below, a previously derived calibration may be applied during the generation of a modulation signal, where this calibration may assist the invention in providing corrected range values.

Preferably the captured and compiled camera data set may be processed by performing a spectral analysis to identify frequency values indicative of range information for objects reflecting light on to the camera sensor. For example in some embodiments a Fourier transform may be applied to the camera data frames of the data set with the transformed data providing information in the frequency domain. This information from the transformed data set can identify both a frequency value in addition to a phase value, this information being representative of a particular distance from the camera system. This frequency value may be correlated directly with a corresponding range or distance value from the camera, while the associated phase value can provide a further more precise distance shift or correction to the distance indicated by the frequency value. This spectral analysis process may therefore be used to firstly identify particular frequency values for ranges of objects reflecting light to the camera, and then to refine these range values more precisely using phase information associated with the identified frequency value.

Preferably the estimated range value may be extracted from the results of the spectral analysis by initially identifying the presence of an object in the field of view of the camera from a spectral intensity peak associated with a particular frequency value. This particular frequency value may be used to determine an estimate range value.

In various embodiments a frequency value may be represented or identified by an index value within the results of the spectral analysis completed by the invention. An index value can identify where in the spectrum a particular frequency resides, with the lowest frequency considered having an index value of 1 and the highest frequency considered having the highest index value used.

An estimated range value may then be calculated from the identified frequency and/or index value using the camera’s range resolution — this being the distance spanned by individual adjacent frequencies. Range resolution can be represented by:

$$Δ R = \frac{c}{2 B}$$

Where c is the speed of light and B is the bandwidth of the frequencies used by the camera as modulation signals.

In embodiments where an index value (i) is identified for a particular frequency an estimated camera range value may be determined by multiplying this index value by the camera range resolution, as per the following expression:

$$E s t i m a t e d r a n g e = i \frac{c}{2 B}$$

In other embodiments an equivalent calculation may determine an estimated range value using the frequency peak of interest ωₑₛₜ extracted from the results of the spectral analysis using the expression:

$$E s t i m a t e d r a n g e = \frac{2 c {ω}_{e s t}}{B}$$

In various embodiments a corrected range value is calculated using a function acting on the calculated estimated range value and adding or subtracting a correction variable given by the expression:

$$C o r r e c t e d r a n g e = E s t i m a t e d r a n g e \pm \frac{c}{2 \left(B + K Δ f\right)}$$

In this expression c is the speed of light and B is the bandwidth of the frequencies used by the camera as modulation signals and Δf is the offset frequency value. The variable K is a scaling factor set depending on how the camera is configured to capture data frames. When the data frames of a data set are ordered from the minimum up to the maximum modulation frequency and include a zero frequency measurement, the derived spectral phase and range phase cover the same bandwidth which leads to K = 0. The data set frames may alternatively be ordered from the maximum down to the minimum modulation frequency where a zero frequency measurement is not included, the derived spectral phase and range phase no longer cover the same bandwidth and we have K = 2 when the minimum modulation frequency is Δf. Those skilled in the art will also appreciate that other camera operation configurations can also be used but increasing values of K reduce the maximum correction which can be applied to the estimated range.

In embodiments where the camera processes the data set ordered with the lowest modulation frequency captured frame first this expression is added to the estimated range value to provide the corrected range value. Conversely, if the data set is ordered with the highest modulation frequency captured frame first then this correction variable should be subtracted.

In some embodiments the phase of the source modulation frequency may also be modified through the addition of an offset phase value each time the modulation frequency is modified. In yet other variations the phase of the source modulation frequency may be modified through the subtraction of this offset phase value each time a modulation frequency is modified. In such embodiments the frequency values falling within a noise shift frequency band can be ignored and invalidated so as to prevent their related corrected range values from being presented as a camera output. The phase shifts applied results in signal returns from objects reflecting light to the camera being frequency shifted from signals sourced from noise present within the noise shift frequency band. In this way valid object return information can be retained while non-object noise returns can be ignored.

A calibration procedure may be completed with the camera prior to the capture of a data set. Such a calibration procedure may, for example, utilise an array of standard objects placed in the field of view of the camera at known distances. Data frames recorded by the camera during this process can then be used to prepare a calibration. This calibration can be utilised so that once a spectral analysis has been completed using the calibrated frames a frequency, phase pair associated with a frequency value of 0 Hz would have a phase value of 0 degrees. In further embodiments the phase values of each pair may also vary linearly with frequency.

Preferably a calibration prepared for use with the invention may define a rotation to be applied to a phase value associated with a particular frequency used as a modulation signal. In various embodiments this calibration may for example be implemented as a lookup table which correlates phase rotation values to specific modulation frequency values.

Preferably a calibration prepared for use with the present invention may be generated by capturing several collections of data frames using a single modulation frequency but where this modulation frequency has a different phase value for each frame. For the selected modulation frequency used a collection of frames can be compiled to generate a complex phasor with an angle indicative of the phase response of the camera at the selected modulation frequency. Multiple collections of data frames can be captured in the preparation of such a calibration, each collection being for a modulation frequency to be used to capture a camera data set. Furthermore in various embodiments the order in which each modulation frequency is used to capture a collection of data frames may be the same order in which these modulation frequencies are used to capture a data set, or in which the frames of the data set are ordered prior to undergoing spectral analysis.

This calibration process will therefore yield a complex phasor angle for each modulation frequency to be used, and a curve fitting process may be completed to derive a rotation to be applied to each phase value associated with a particular frequency. This curve fitting process can compare the difference between the measured complex phasor angle and the angle expected from an ideal phase response which satisfies the required outcome of the calibration. This comparison will therefore yield the phase rotation value which needs to be applied at a particular modulation frequency which will result in a frequency, phase pair associated with a frequency value of 0 Hz having a phase value of 0 degrees when interpolated from the results of the spectral analysis obtained. In further embodiments the phase values of each pair may also be rotated so that they vary linearly with frequency.

The calibration may also be deployed or used in several ways in different embodiments. For example, in some embodiments the calibration may be used to modify the phase of a modulation signal of a particular frequency which is to be used to capture a data frame. In this way the invention applies a calibration during the capture of the data set.

In other embodiments the calibration may be implemented in a software process with a pre-processing algorithm applied to captured data sets. In such embodiments the data set of captured frames may include multiple frames captured at the same modulation frequency but with a different phase values applied. This collection of frames captured at the same frequency can then be combined to provide complex paired amplitude and phase information. The calibration provided for use with the invention may then apply the identified rotation to the phase information for the modulation frequency used, and the resulting data frame can then be used in the spectral analysis used by the invention.

In a further preferred embodiment the calibration procedure referenced above may also integrate a windowing function in respect of the captured dataset. The windowing function can be tailored to offer better performance for closely interfering returns, or for sparsely interfering returns. The application of a Hanning window provides excellent performance when there is multiple interference that is sufficiently separated by the range resolution of the camera.

In some embodiments the present invention is arranged to order captured data frames in the camera data set to present the camera data frame captured using light modulated with the highest frequency modulation signal as the first data frame of the camera data set. A camera data set compiled in accordance with this embodiment will therefore always start with this maximum modulation frequency frame, with the remaining frames of the set being captured with lower modulation frequencies. In a further preferred embodiment each successive frame integrated into this data set may be provided by the frame captured using the next highest frequency modulation signal, with the final frame of the data set being that captured with the lowest frequency modulation signal.

This ordering or sequencing of the frames of the data set based on modulation frequency may be undertaken in different ways in different embodiments.

For example, in one embodiment the data frame acquisition process may ensure that the frequency of the modulation signal used decreases for each successive frame being captured. In such embodiments an initial or source modulation frequency may be used to start the data frame acquisition process, this source modulation frequency being the highest modulation frequency used. A step frequency value may then be subtracted from the source modulation frequency to provide the frequency of the next modulation signal used to capture a data frame, with the frequency of the modulation signal again being reduced by this step frequency value as each frame is captured. Therefore with this approach the captured data frames can be complied as a data set in the order in which they are generated, eliminating any need to undertake a re-ordering process on the data set.

In further preferred forms of such embodiments the phase of the source modulation frequency may also be modified through the addition of an offset phase value each time the modulation frequency is decreased. In yet other variations the phase of the source modulation frequency may be modified through the subtraction of this offset phase value each time a modulation frequency is decreased.

Alternatively in other embodiments the frequency of the modulation signal used to capture each data frame need not successively decrease with each captured frame. In such embodiments data frames may — for example — be captured using a modulation signal which increases by the step frequency value with the capture of each successive frame, or with the use of a set of step frequency modulation signals utilised in any desired order or sequence. In further preferred embodiments each change in the frequency of the modulation signal using a step frequency value may also be accompanied by a change in the phase of the modulation signal using an offset phase value. The data frames captured in such embodiments may then be compiled as a data set with the use of an ordering process which sorts the frames into the data set based on the frequency of the modulation signal used to capture each frame. This ordering process may therefore be used to present the camera data frame captured using light modulated with the highest frequency modulation signal as the first data frame of the camera data set.

In further embodiments of the invention additional processing may be undertaken on the captured camera data set after the camera data frames have been processed to determine range information.

For example in one embodiment an additional harmonic error invalidation step may be completed by the processor after corrected range information has been determined and before a camera output has been provided. In such embodiments a corrected camera range value can be validated by comparison against known harmonic error artefacts which present as objects at know ranges to the camera. Corrected range values at these range values may be invalidated and removed from the camera output to be provided.

In other embodiments this additional processing may involve reordering the data frames within the dataset to present the camera data frame captured using light modulated with the lowest frequency modulation signal as the first data frame of the camera data set.

Those skilled in the art will appreciate that data frames may be captured using any desired sequence, order or arrangement of modulation frequencies, and then subsequently reordered in the resulting data set to order frames captured with either regularly increasing or decreasing modulation frequencies.

In yet other embodiments a selected subset, or a series of subsets of the data frames present within the original data set may be selected for additional processing.

This additional processing of the re-ordered dataset or selected subsets of the original data set may preferably be completed by performing a spectral analysis to identify frequency values indicative of range information for objects reflecting light on to the camera sensor. This additional spectral analysis can potentially allow for the identification of movement in objects as the camera is capturing data frames, to error check the consistency of the originally generated range information, and/or to improve the signal-to-noise ratio of the captured data frames.

The present invention may provide potential advantages over prior art. In particular the present invention may provide improvements in relation to prior art step frequency continuous wave time-of-flight camera systems, providing an alternative to prior art techniques which require the use of zero padding spectral interpolation processes. In various embodiments the present invention may be configured to provide comparatively accurate results without the need to generate and process a significantly enlarged camera data set generated by the zero padding process. This in turn leads to computational efficiencies, allowing the invention to implement a relatively low cost SFCW time-of-flight camera with inexpensive processing components, or equivalent cameras which can operate at high speeds.

In various additional embodiments the invention may also utilise changes in frequency of the modulation signal accompanied by changes in phase of the same modulation signal. This approach can allow for a reduction in error or noise in the resulting captured data frames.

Additional processing steps may also be undertaken on appropriately sequenced or reordered datasets provided in accordance with the invention. After initial processing steps have been taken to determine range information the dataset may be reordered or subsets of the original dataset may be selected for further spectral analysis processing. This additional processing can be used to identify moving objects, consistency check the range information being generated and/or to provide signal-to-noise improvements.

Those skilled in the art will also appreciate that the method, apparatus and instruction sets described above in respect of the invention may also be combined with existing prior art time-of-flight camera technology. For example in some instances a hybrid camera system may be implemented using the present invention combining both shifted frequency continuous wave and amplitude modulated continuous wave data acquisition processes.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1 shows a block schematic diagram of the components of the time-of-flight camera provided in accordance with one embodiment of the invention,

FIG. 2 shows a flowchart of a program of computer executable instructions arranged to operate the time of flight camera of FIG. 1 as provided in accordance with one embodiment,

FIG. 3 shows a flowchart of a program of computer executable instructions arranged to operate the time of flight camera of FIG. 1 as provided in accordance with an alternative embodiment to that described with respect FIG. 2,

FIG. 4 shows a plot of single pixel raw amplitude values recorded during the capture of a sequence of camera data frames by a time of flight camera programed with the executable instructions illustrated with respect to FIG. 3,

FIGS. 5a, 5b show comparative plots of phase versus frequency of modulation signals used by the invention prior to and after the application of a calibration,

FIGS. 6a, 6b show comparative plots of amplitude versus modulation frequency for frame data prior to and after the application of a calibration which also implements a Hanning window function to reduce spectral leakage noise,

FIGS. 7a, 7b show comparative plots of the spectral analysis and object range results obtained with the prior art, and with use of the invention in one embodiment, and

FIGS. 8a, 8b show comparative plots of the spectral analysis and object range results obtained with the prior art, and with use of the invention in a further embodiment which utilises the Hanning window function illustrated with respect to FIG. 6b.

Further aspects of the invention will become apparent from the following description of the invention which is given by way of example only of particular embodiments.

### BEST MODES FOR CARRYING OUT THE INVENTION

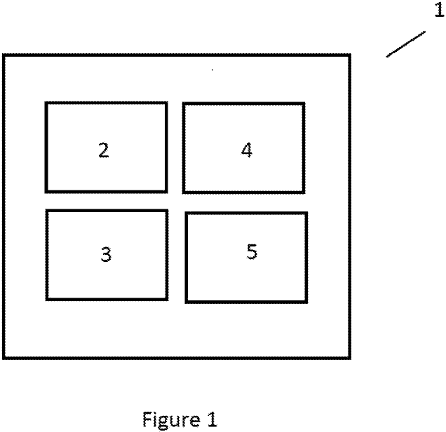

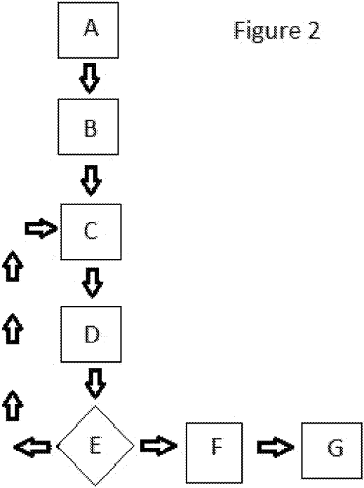

FIG. 1 shows a block schematic diagram of the components of the time-of-flight camera 1 provided in accordance with one embodiment of the invention. The camera 1 incorporates the same components as those utilised with a prior art step frequency continuous wave time of flight camera including a signal generating oscillator 2, light source 3, light sensor 4 and processor 5. The processor 5 is programmed with a set of executable instructions which control the operation of each of the remaining components, as described further with respect to FIG. 2.

FIG. 2 shows the first step A of this operational method where the signal oscillator generates a source modulation signal. Step B is then executed with the light source transmitting light modulated by the source modulation signal and the light sensor capturing a camera data frame.

At step C instructions are executed to modify the source modulation signal with the subtraction of a frequency offset value to provide a stepped modulation signal.

Step D is then executed with the light source transmitting light modulated by the modulation signal generated at step C with the light sensor capturing a further camera data frame.

At step E an assessment is made of the number of data frames captured so far when compared with the number of data frames required for a complete time of flight camera data set. If the data set is incomplete the process returns to step C where the frequency of the last modulation signal used is modified with the subtraction of the frequency offset value.

Once a complete data set has been captured step F is completed to perform a spectral transformation on the captured data frames. In the embodiment shown the spectral transformation is performed using a Fourier transform.

Lastly at step G the values present in the data set are analysed to identify particular frequency and phase values which are associated with objects reflecting light to the camera sensor. Frequency values correlating with the object’s range to the camera are identified, and the phase values associated with them are used to correct or refine the range value provided by the camera for an object.

In this embodiment an estimated range for an object is calculated by identifying intensity peaks in the results of the spectral analysis associated with particular frequency, phase paired values. For a particular intensity peak ωₑₛₜ an estimated range is calculated from the expression:

$$E s t i m a t e d r a n g e = \frac{2 c {ω}_{e s t}}{B}$$

Once this estimated range has been calculated a corrected range is the calculated at step G using the expression:

$$C o r r e c t e d r a n g e = E s t i m a t e d r a n g e \pm \frac{c}{2 \left(B + K Δ f\right)}$$

This corrected range value can then be provided as camera output to complete step G and terminates the operational method of this embodiment. In this embodiment an image is presented as a camera output, where the colour of individual pixels of this image indicate both position and corrected range values for an object in the field of view of the camera.

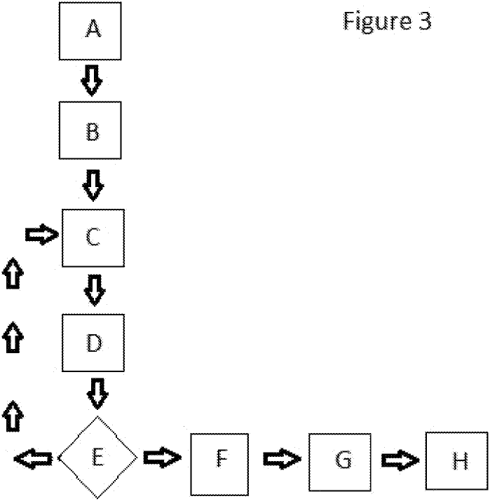

FIG. 3 shows a flow chart of an alternative program of computer executable instructions which can also be arranged to operate the time of flight camera of FIG. 1.

Again the first step A of this operational method is executed to operate the signal oscillator to generate a source modulation signal. This modulation signal is generated with the use of a calibration which makes an adjustment to the phase of the signal so that the results of a spectral analysis yields a zero phase value when interpolated to a zero frequency value. In this embodiment the calibration applied specifies a rotation to be applied to a phase value associated with each modulation frequency used to capture a data frame.

In various additional embodiments this calibration can also be used to ensure that the phase of the modulation signal varies linearly with respect to the frequency of the modulation signal. Additional embodiments can also utilise this calibration to implement a windowing function in addition to adjustments to the phase of the modulation signal as referenced above.

Step B is then executed with the light source transmitting light modulated by the source modulation signal and the light sensor capturing a camera data frame. In this embodiment a captured camera data frame is supplied as an input to a ‘first in last out’ or FILO buffer memory structure implemented by the camera processor.

At step C instructions are executed to modify the source modulation signal with the addition of a frequency offset value to provide a stepped modulation signal. Again the same calibration use with respect to step A is used to adjust the phase of the resulting stepped modulation signal.

Step D is then executed with the light source transmitting light modulated by the modulation signal generated at step C with the light sensor capturing a further camera data frame. Again this captured data frame is supplied as the next input to the above referenced FILO buffer.

At step E an assessment is made of the number of data frames captured so far when compared with the number of data frames required for a complete time of flight camera data set. If the data set is incomplete the process returns to step C where the frequency of the last modulation signal used is modified with the addition of the frequency offset value.

At step F an ordering process is completed to compile the full set of captured data frames into a simple data set. In this embodiment the contents of the FILO buffer are read out, thereby reordering the stored data frames in the sequence provided in accordance with the invention.

Once the complete correctly ordered data set has been compiled step G is completed to perform a spectral transformation. In the embodiment shown the spectral transformation is performed using a Fourier transform.

Lastly at step H the values present in the data set are analysed to identify particular frequency and phase values which are associated with objects reflecting light to the camera sensor. Again frequency values correlating with the object’s range to the camera are identified, and the phase values associated with them are used to correct or refine the range value provided by the camera for an object. In such embodiments step H executes a similar process to that discussed with respect to step G of FIG. 2. In particular, an estimated range for an object is calculated by identifying intensity peaks in the results of the spectral analysis associated with particular frequency, phase paired values. For a particular intensity peak at frequency ωₑₛₜ an estimated range is calculated from the expression:

$$E s t i m a t e d r a n g e = \frac{2 c {ω}_{e s t}}{B}$$

Once this estimated range has been calculated a corrected range is the calculated at step H using the expression:

$$C o r r e c t e d r a n g e = E s t i m a t e d r a n g e \pm \frac{c}{2 \left(B + K Δ f\right)}$$

This corrected range value can then be provided as camera output to complete step H and terminate the operational method of this embodiment. In this embodiment camera output is provided to a machine vision system, where the format and content delivered is determined by the requirements of the receiving system.

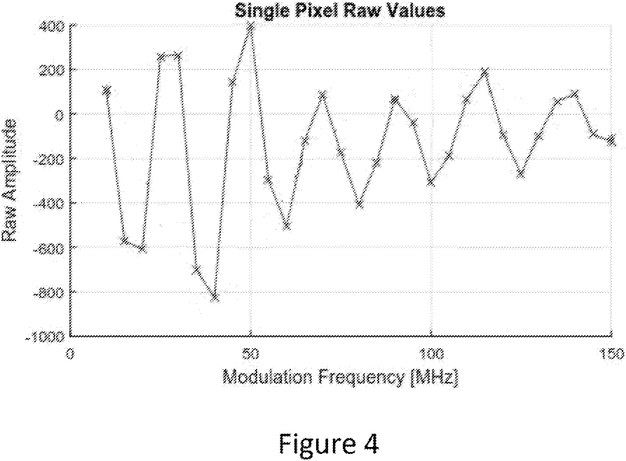

FIG. 4 shows a plot of single pixel raw amplitude values recorded during the capture of a sequence of camera data frames undertaken by a time of flight camera programed with the executable instructions illustrated with respect to FIG. 3. This plot illustrates how 29 camera data frames are captured using a step frequency value of 5 MHz. The modulation frequency used starts at 10 MHz with the final data frame captured at the modulation frequency of 150 MHz.

Raw amplitude values are captured over time as modulation frequencies are increased and FIG. 4 shows a clear oscillating signal with a defined frequency. Spectral analysis of this data will identify a power peak at the frequency of this oscillating signal, with this frequency correlating to the range of an object reflecting light onto the camera sensor.

Using the operational method described with respect to FIG. 3 a camera data set is compiled from the plot of raw frame actions to values shown, with the first element of the data set being the measurement captured with modulation frequency of 150 Mhz. The next frame integrated into the data set is the measurement captured at 145 MHz, with the final frame integrated into the data set being measurement captured at 10 MHz.

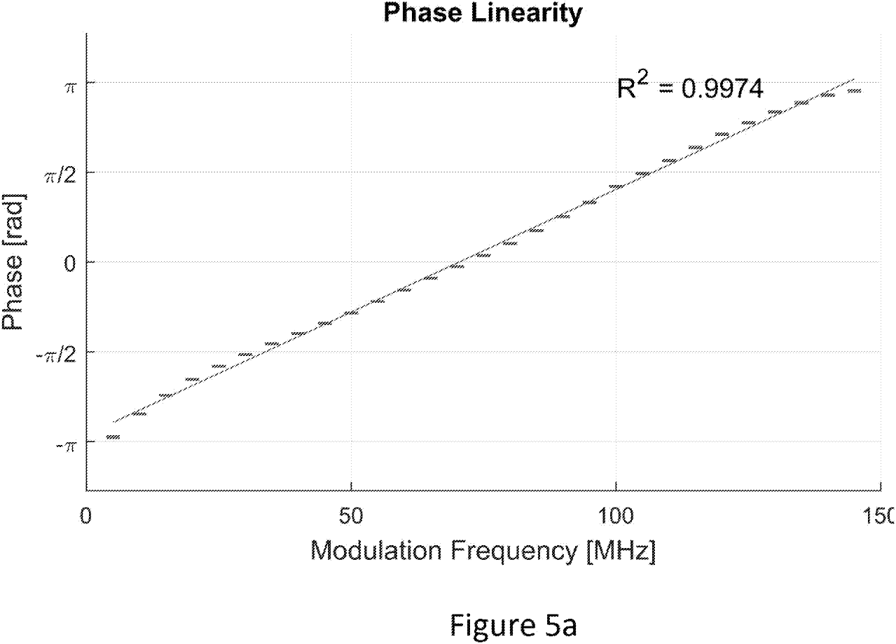

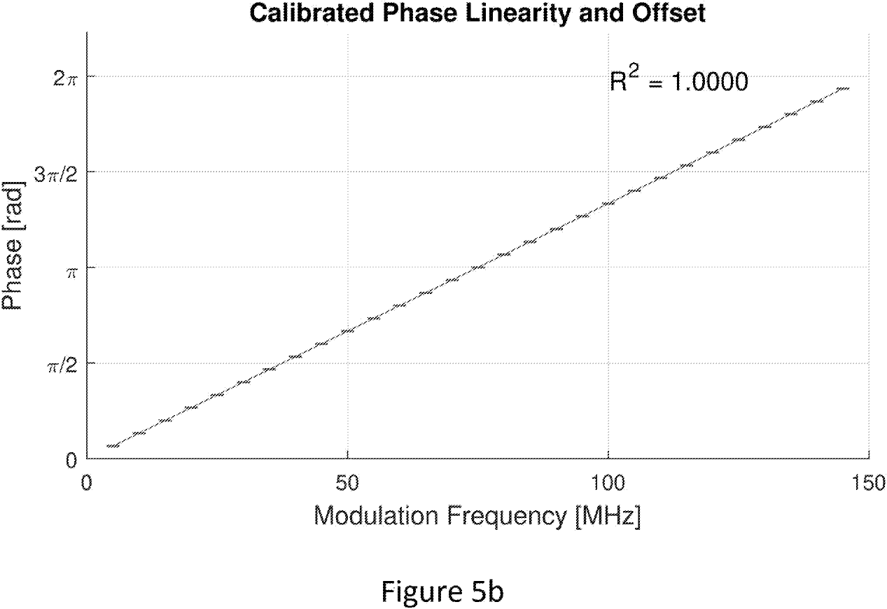

FIGS. 5a, 5b show comparative plots of phase versus frequency of modulation signals used by the invention prior to and after the application of a calibration.

As can be seen from FIG. 5a the actual phase values indicated by the dashed data points cycle above and below the solid line identifying a linear response to modulation frequency. The phase response with frequency is also offset so that a non-zero phase will be present at a OHz modulation frequency.

FIG. 5b illustrates the results of the calibration applied in accordance with various embodiments of the invention. In this embodiment the phase of the modulation signal has been adjusted to vary linearly with frequency. The offset illustrated with respect to FIG. 5a has also been removed so that a zero phase value will result at a 0 Hz modulation frequency.

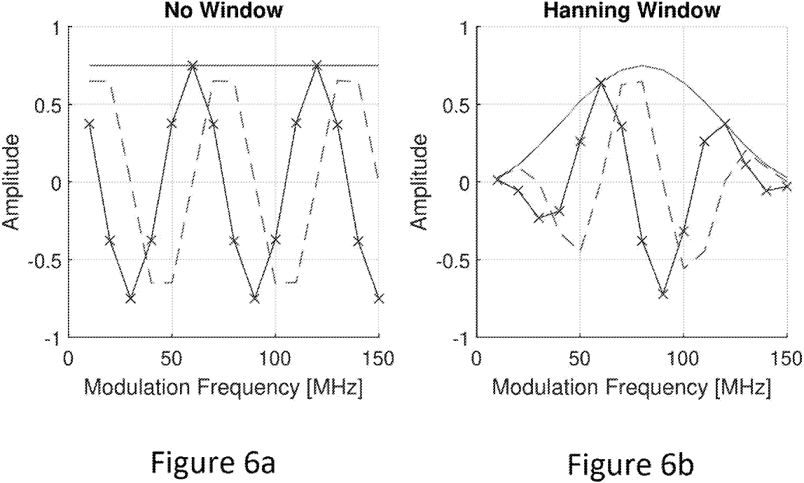

FIGS. 6a, 6b show comparative plots of amplitude versus modulation frequency for frame data prior to and after the application of a calibration which also implements a Hanning window function to reduce spectral leakage noise. Sufficient data frames have been captured in the embodiment shown to allow this data to be formatted as a combination of real (X data points) and imaginary numbers (dashed data points).

As can be seen from FIG. 6a no restrictions are applied to the amplitude results obtained from these frames. FIG. 6b shows the application of a Hanning window function within a calibration equivalent to that discussed with respect to FIG. 5b. As can be seen from FIG. 6b amplitude values are scaled to sit underneath the solid curve shown at the uppermost region of this plot. To reduce spectral leakage noise amplitude values are attenuated by the windowing function as the minimum and maximum modulation frequency used are approached.

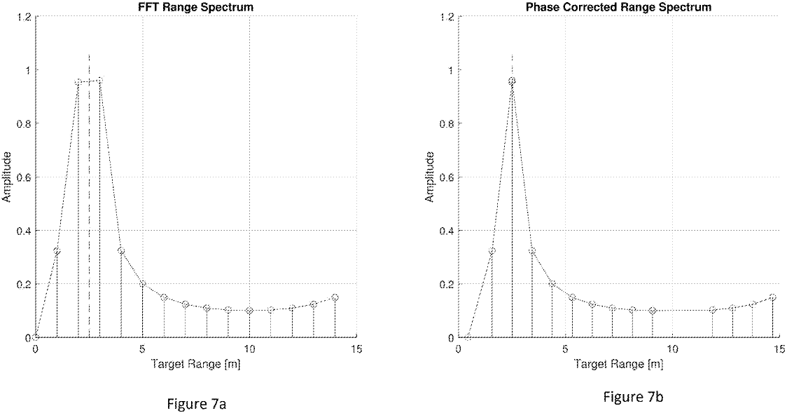

FIGS. 7a, 7b show comparative plots of the spectral analysis and object range results obtained with the prior art, and with use of the invention in one embodiment. For convenience range to target in meters has been derived from frequency values for both plots shown. Each plot also identifies the correct actual range of an object in the field of view of the camera at a range of 2.5 m.

FIG. 7a shows results obtained with the prior art where an estimated range value only is available and determined using frequency information in isolation. As can be seen from this figure an ambiguous range result is obtained from the 3^{rd} and 4^{th} data point peaks. This prior art implementation therefore identifies two possible objects present at both 2 m and 3 m respectively.

FIG. 7b shows results obtained by the invention in one embodiment where the estimated range values illustrated by FIG. 7a are used in combination with phase information to result in the corrected range value illustrated as the 3^{rd} data point. In the embodiment shown this phase based correction applied to estimated range values combines the two adjacent ambiguous peaks of FIG. 7a into a single accurate 2.5 m corrected range value.

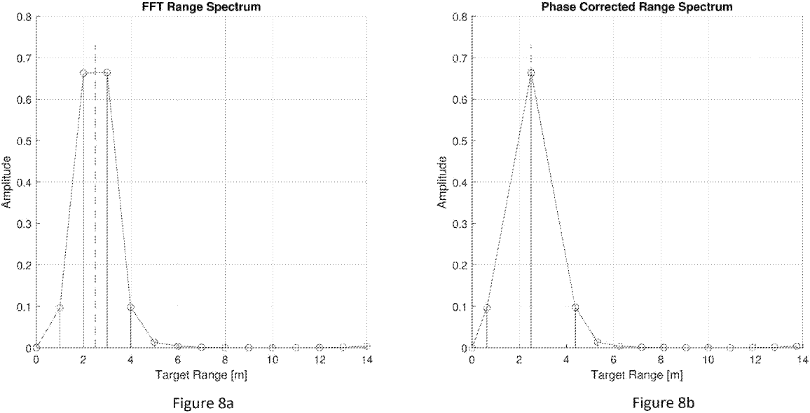

FIGS. 8a, 8b show comparative plots of the spectral analysis and object range results obtained with the prior art, and with use of the invention in a further embodiment which utilises the Hanning window function illustrated with respect to FIG. 6b. FIGS. 8a and 8b also illustrate the same circumstances as the plots of FIGS. 7a, 7b with an object in the field of view of the camera at 2.5 m.

Similarly to FIGS. 7a and 7b, in the embodiment shown the use of the invention results in the provision of a single unambiguous peak at 2.5 m with FIG. 8b, compared to the two ambiguous peaks of FIG. 8a at 2 m and 3 m. These figures also show the results of using the Hanning window function discussed with respect to FIG. 6b. As can be seen from a comparison with FIGS. 7a, 7b the prior noise peaks shown at larger ranges have been attenuated due to the windowing function reducing spectral leakage effects.

In the preceding description and the following claims the word “comprise” or equivalent variations thereof is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

What we claim is:

1. A time of flight camera which includes
a signal generator configured to generate a source modulation signal and to modify the frequency of the source modulation signal by at least one multiple of an offset frequency,
a camera light source configured to transmit light modulated by a modulation signal generated by the signal generator
a camera sensor configured to capture time of flight camera data frames from received reflected light,
a processor configured to compile a data set from captured time of flight data frames and to
complete a spectral analysis of the received dataset which identifies frequency and phase value pairs indicative of the range of the camera to an object represented in the data frames, and
determine an estimated camera range value to an object represented in the data frames using the frequency value, and
determine a corrected camera range value using the estimated camera range value and the phase value, and
providing a camera output which identifies the corrected range values of objects represented in the data frames of the dataset.

2. The time of flight camera of claim 1 wherein the processor is configured to apply a calibration to the frames of the captured data set or during the capture of the data set so that the results of the spectral analysis yields a zero phase value when interpolated to a zero frequency value.

3. The time of flight camera of claim 2 wherein the calibration applied specifies a rotation to be applied to a phase value associated with each modulation frequency used to capture a data frame,.

4. The time of flight camera of claim 2 wherein the calibration applied implements a windowing function.

5. The time of flight camera of claim 1 wherein the estimated camera range value is determined by the expression:
$$E s t i m a t e d r a n g e = \frac{2 c {ω}_{e s t}}{B}$$
where c is the speed of light, ωₑₛₜ is a frequency exhibiting a peak in the spectral analysis and B is the bandwidth of the frequencies used by the camera as modulation signals.

6. The time of flight camera of claim 1 wherein the estimated camera range value is determined by multiplying an index value associated with the frequency by the range resolution of the camera.

7. The time of flight camera of claim 1 wherein the corrected camera range value is determined by adding or subtracting from the estimated range value a correction variable defined by the expression:
$$C o r r e c t e d r a n g e = E s t i m a t e d r a n g e \pm \frac{c}{2 \left(B + K Δ f\right)}$$
where c is the speed of light, B is the bandwidth of the frequencies used by the camera as modulation signals, Δƒ is an offset frequency value and K is a scaling factor.

8. The time of flight camera of claim 7 wherein the correction variable is added when the dataset is ordered with the lowest modulation frequency captured frame first, and the correction variable is subtracted when the data set is ordered with the highest modulation frequency captured frame first.

9. The time of flight camera of claim 1 wherein the captured data frames of the dataset are ordered prior to spectral analysis being completed to present the camera data frame captured using light modulated with the highest frequency modulation signal as the first data frame of the camera data set with each subsequent frame being captured using the next highest frequency modulation signal.

10. The time of flight camera of claim 1 wherein the data frames of the dataset are captured using light modulated with the highest frequency modulation signal as the first data frame of the camera data set with each subsequent frame being captured using the next highest frequency modulation signal.

11. The time of flight camera of claim 1 wherein the captured data frames of the dataset are ordered prior to spectral analysis being completed to present the camera data frame captured using light modulated with the lowest frequency modulation signal as the first data frame of the camera data set with each subsequent frame being captured using the next lowest frequency modulation signal.

12. The time of flight camera of claim 1 wherein the data frames of the dataset are captured using light modulated with the lowest frequency modulation signal as the first data frame of the camera data set with each subsequent frame being captured using the next lowest frequency modulation signal.

13. The time of flight camera of claim 1 which includes the additional step of validating a corrected camera range value against known harmonic artefacts and removing invalidated corrected range values from the camera output.

14. A set of computer executable instructions for a processor of a time of flight camera, said instructions executing the steps of:
capturing a sequence of time of flight camera data frames using a set of step frequency modulation signals to provide a time of flight camera data set,
completing a spectral analysis of the dataset which identifies frequency and phase value pairs indicative of the range of the camera to an object represented in the data frames, and
determining an estimated camera range value to an object represented in the data frames using the frequency value, and
determining a corrected camera range value using the estimated camera range value and the phase value, and
providing a camera output which identifies the corrected range values of at least one object represented in the data frames of the dataset.

15. The set of computer executable instructions of claim 14 which includes the additional instruction step of applying a calibration to the frames of the captured data set so that the results of the spectral analysis yields a zero phase value when interpolated to a zero frequency value.

16. The set of computer executable instructions of claim 15 wherein the calibration applied specifies a rotation to be applied to a phase value associated with each modulation frequency used to capture a data frame.

17. A method of operating a time of flight camera which includes the steps of:
capturing a sequence of time of flight camera data frames using a set of step frequency modulation signals to provide a time of flight camera data set,
completing a spectral analysis of the data set which identifies frequency and phase value pairs indicative of the range of the camera to an object represented in the data frames, and
determining an estimated camera range value to an object represented in the data frames using the frequency value, and
determining a corrected camera range value using the estimated camera range value and the phase value, and
providing a camera output which identifies the corrected range values of at least one object represented in the data frames of the data set.

18. The method of claim 17 which includes the additional step of applying a calibration to the frames of the captured data set so that the results of the spectral analysis yields a zero phase value when interpolated to a zero frequency value.

19. The method of claim 18 wherein the calibration applied specifies a rotation to be applied to a phase value associated with each modulation frequency used to capture a data frame.
